(19) United States
(12) Patent Application Publication
(10) Pub. No.: US 2024/0066998 A1
(43) Pub. Date: Feb. 29, 2024

(54) PEDAL CONTROL SYSTEM AND METHOD FOR AN ELECTRIC VEHICLE

(71) Applicant: NISSAN NORTH AMERICA, INC., Franklin, TN (US)

(72) Inventors: Sachin HAGARIBOMMANAHALLI, Santa Clara, CA (US); Christopher OSTAFEW, Mountain View, CA (US)

(21) Appl. No.: 17/900,778

(22) Filed: Aug. 31, 2022

(51) Int. Cl. B60L 15/20; B60L 7/18

(52) U.S. Cl. CPC B60L 15/2009; B60L 7/18; B60L 2240/423; B60L 2240/66; B60L 2250/26

(57) ABSTRACT

A pedal control system for an electric vehicle includes a pedal, a first switch, a second switch, and an electronic controller. The pedal is configured to be operated in a first mode or a second mode. The first mode does not include regenerative braking and the second mode includes regenerative braking. The second mode includes a plurality of sub-modes. The first switch is configured to switch between the first mode and the second mode. The second switch is configured to select one of the plurality of sub-modes when the second mode is selected. The electronic controller is configured to control an operating mode of the pedal when the second mode is selected. Each of the plurality of sub-modes has a different rate of deceleration and regeneration.

### BACKGROUND

### Technical Field

The present disclosure generally relates to a system and method of controlling a pedal of an electric vehicle. More specifically, the present disclosure relates to automatically selecting a predefined sub-mode when an automatic sub-mode is manually selected.

### Background Information

One-pedal functionality in vehicles allows a driver to drive without using a brake pedal. The driver regulates relatively large deceleration rates using only an accelerator pedal. However, the vehicle can decelerate too much when the driver releases the accelerator pedal, such as when cruising on a highway. Increased attention of the driver is required to carefully regulate the speed of the vehicle. The vehicle can also not decelerate quickly enough when the driver releases the accelerator pedal, such as when a vehicle ahead begins to decelerate rapidly. A stress level of the driver is increased in these situations.

### SUMMARY

A need exists for a pedal control system and method for an electric vehicle.

In view of the state of the known technology, one aspect of the present disclosure is to provide a pedal control system for an electric vehicle including a pedal, a first switch, a second switch, and an electronic controller. The pedal is configured to be operated in a first mode or a second mode. The first mode does not include regenerative braking and the second mode includes regenerative braking. The second mode includes a plurality of sub-modes. The first switch is configured to switch between the first mode and the second mode. The second switch is configured to select one of the plurality of sub-modes when the second mode is selected. The electronic controller is configured to control an operating mode of the pedal when the second mode is selected. Each of the plurality of sub-modes has a different rate of deceleration and regeneration.

Another aspect of the present disclosure is to provide a method of controlling an electric vehicle. A pedal is selected to be operated in accordance with a first mode or a second mode. The first mode does not include regenerative braking and the second mode includes regenerative braking. The second mode includes a plurality of sub-modes. One of the plurality of sub-modes is selected when the second mode is selected. An operating mode of the pedal is controlled when the second mode is selected. Each of the plurality of sub-modes has a different rate of deceleration and regeneration.

Also other objects, features, aspects and advantages of the disclosed pedal control system and method for an electric vehicle will become apparent to those skilled in the art from the following detailed description, which, taken in conjunction with the annexed drawings, discloses exemplary embodiments of the pedal control system and method for an electric vehicle.

### BRIEF DESCRIPTION OF THE DRAWINGS

Referring now to the attached drawings which form a part of this original disclosure:

FIG. 1 is a diagram of an example of a vehicle in accordance with an exemplary embodiment;

FIG. 2 is a diagram of a communication system of the vehicle of FIG. 1;

FIG. 3 is a diagram of a one-pedal control system for use in a vehicle in accordance with this disclosure:

FIG. 4 is an elevational view of an instrument panel of the vehicle of FIG. 1 equipped with the pedal control system;

FIG. 4 is a schematic of the one-pedal control system;

FIG. 6 is a schematic illustration of a reactive component of an automatic sub-mode pedal control system;

FIG. 7 is a schematic illustration of a proactive component of an automatic sub-mode pedal control system; and

FIG. 8 is a flowchart of the automatic sub-mode pedal control system.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

Although described herein with reference to an electric vehicle, the methods and apparatus described herein may be implemented in any vehicle capable of one-pedal operation.

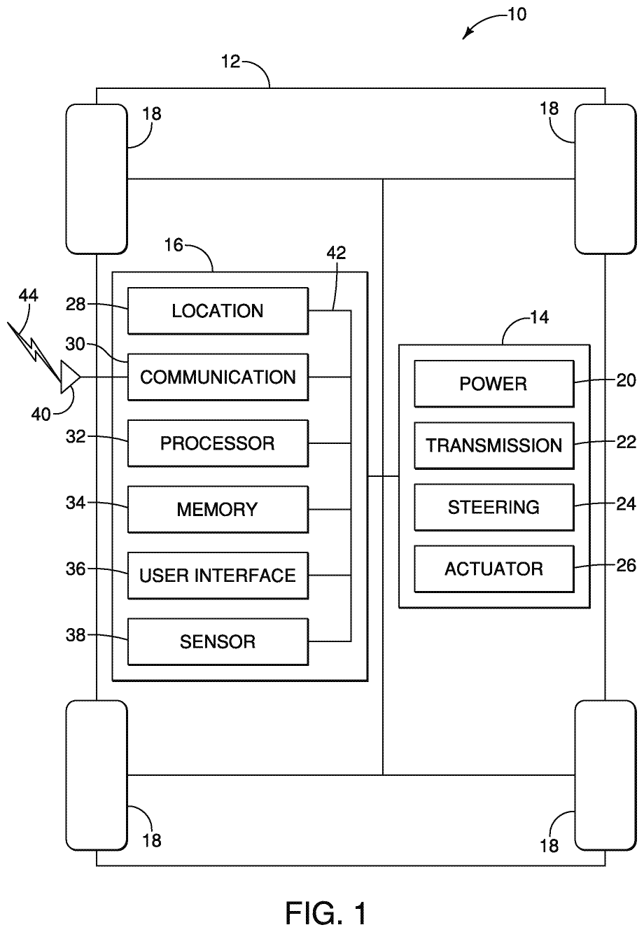

FIG. 1 is a diagram of an example of an electric vehicle in accordance with an exemplary embodiment in which the features, and elements disclosed herein may be implemented. As shown, a vehicle 10 includes a chassis 12, a powertrain 14, a controller 16, and wheels 18. Although the vehicle 10 is shown as including four wheels 18 for simplicity, any other propulsion device or devices, such as a propeller or tread, may be used. In FIG. 1, the lines interconnecting elements, such as the powertrain 12, the controller 16, and the wheels 18, indicate that information, such as data or control signals, power, such as electrical power or torque, or both information and power, may be communicated between the respective elements. For example, the controller 16 may receive power from the powertrain 14 and may communicate with the powertrain 14, the wheels 18, or both, to control the vehicle 10, which may include accelerating, decelerating, steering, or otherwise controlling the vehicle 10.

As shown, the powertrain 14 includes a power source 20, a transmission 22, a steering unit 24, and an actuator 26. Other elements or combinations of elements of a powertrain, such as a suspension, a drive shaft, axles, or an exhaust system may be included. Although shown separately, the wheels 18 may be included in the powertrain 14.

The power source 20 may include an engine, a battery, or a combination thereof. The power source 20 may be any device or combination of devices operative to provide energy, such as electrical energy, thermal energy, or kinetic energy. For example, the power source 20 may include an engine, such as an internal combustion engine, an electric motor, or a combination of an internal combustion engine and an electric motor, and may be operative to provide kinetic energy as a motive force to one or more of the wheels 18. The power source 20 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 22 may receive energy, such as kinetic energy, from the power source 20, and may transmit the energy to the wheels 18 to provide a motive force. The transmission 22 may be controlled by the controller 16, the actuator 26, or both. The steering unit 24 may be controlled by the controller 16, the actuator 26, or both, and may control the wheels 18 to steer the vehicle 10. The actuator 26 may receive signals from the controller 16 and may actuate or control the power source 20, the transmission 22, the steering unit 24, or any combination thereof to operate the vehicle 10.

As shown, the controller 16 may include a location unit 28, an electronic communication unit 30, a processor 32, a memory 34, a user interface 36, a sensor 38, an electronic communication interface 40, or any combination thereof. Although shown as a single unit, any one or more elements of the controller 16 may be integrated into any number of separate physical units. For example, the user interface 36 and the processor 32 may be integrated in a first physical unit and the memory 34 may be integrated in a second physical unit. Although not shown in FIG. 1, the controller 16 may include a power source, such as a battery. Although shown as separate elements, the location unit 28, the electronic communication unit 30, the processor 32, the memory 34, the user interface 36, the sensor 38, the electronic communication interface 40, or any combination thereof may be integrated in one or more electronic units, circuits, or chips.

The processor 32 may include any device or combination of devices capable of manipulating or processing a signal or other information now-existing or hereafter developed, including optical processors, quantum processors, molecular processors, or a combination thereof. For example, the processor 32 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 32 may be operatively coupled with the location unit 28, the memory 34, the electronic communication interface 40, the electronic communication unit 30, the user interface 36, the sensor 38, the powertrain 14, or any combination thereof. For example, the processor may be operatively coupled with the memory 34 via a communication bus 42.

The memory 34 may include any tangible non-transitory computer-usable or computer-readable medium, capable of, for example, containing, storing, communicating, or transporting machine readable instructions, or any information associated therewith, for use by or in connection with the processor 32. The memory 34 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 40 may be a wireless antenna, as shown, a wired communication port, an optical communication port, or any other wired or wireless unit capable of interfacing with a wired or wireless electronic communication medium 44. Although FIG. 1 shows the communication interface 40 communicating via a single communication link, a communication interface may be configured to communicate via multiple communication links. Although FIG. 1 shows a single communication interface 40, a vehicle may include any number of communication interfaces.

The communication unit 30 may be configured to transmit or receive signals via a wired or wireless electronic communication medium 44, such as via the communication interface 40. Although not explicitly shown in FIG. 1, the communication unit 30 may be configured to transmit, receive, or both via any wired or wireless communication medium, such as radio frequency (RF), ultraviolet (UV), visible light, fiber optic, wireline, or a combination thereof. Although FIG. 1 shows a single communication unit 30 and a single communication interface 40, any number of communication units and any number of communication interfaces may be used. In some embodiments, the communication unit 30 may include a dedicated short-range communications (DSRC) unit, an on-board unit (OBU), or a combination thereof.

The location unit 28 may determine geolocation information, such as longitude latitude, elevation, direction of travel, or speed, of the vehicle 10. For example, the location unit may include a global positioning system (GPS) unit, such as a Wide Area Augmentation System (WAAS) enabled National Marine-Electronics Association (NMEA) unit, a radio triangulation unit, or a combination thereof. The location unit 28 can be used to obtain information that represents, for example, a current heading of the vehicle 10, a current position of the vehicle 10 in two or three dimensions, a current angular orientation of the vehicle 10, or a combination thereof.

The user interface 36 may include any unit capable of interfacing with a person such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 36 may be operatively coupled with the processor 32, as shown, or with any other element of the controller 16. Although shown as a single unit, the user interface 36 may include one or more physical units. For example, the user interface 36 may include an audio interface for performing audio communication with a person and a touch display for performing visual and touch-based communication with the person. The user interface 36 may include multiple displays, such as multiple physically separate units, multiple defined portions within a single physical unit, or a combination thereof.

The sensor 38 may include one or more sensors, such as an array of sensors, which may be operable to provide information that may be used to control the vehicle. The sensors 38 may provide information regarding current operating characteristics of the vehicle 10. The sensor 38 can include, for example, a speed sensor, acceleration sensors, a steering angle sensor, traction-related sensors, braking-related sensors, steering wheel position sensors, eye tracking sensors, seating position sensors, or any sensor, or combination of sensors, operable to report information regarding some aspect of the current dynamic situation of the vehicle 10.

The sensor 38 may include one or more sensors operable to obtain information regarding the physical environment surrounding the vehicle 10. For example, one or more sensors may detect road geometry and features, such as lane lines, and obstacles, such as fixed obstacles, vehicles, and pedestrians. The sensor 38 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 38 and the location unit 28 may be a combined unit.

Although not shown separately, the vehicle 10 may include a trajectory controller. For example, the controller 16 may include the trajectory controller. The trajectory controller may be operable to obtain information describing a current state of the vehicle 10 and a route planned for the vehicle 10, and, based on this information, to determine and optimize a trajectory for the vehicle 10. In some embodiments, the trajectory controller may output signals operable to control the vehicle 10 such that the vehicle 10 follows the trajectory that is determined by the trajectory controller. For example, the output of the trajectory controller can be an optimized trajectory that may be supplied to the powertrain 14, the wheels 18, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 18 may be a steered wheel, which may be pivoted to a steering angle under control of the steering unit 24, a propelled wheel, which may be torqued to propel the vehicle 10 under control of the transmission 22, or a steered and propelled wheel that may steer and propel the vehicle 10.

Although not shown in FIG. 1, a vehicle may include units, or elements, not shown in FIG. 1, such as an enclosure, a Bluetooth®) module, a frequency modulated (FM) radio unit, a Near Field Communication (NFC) module, a liquid crystal display (LCD) display unit, an organic light-emitting diode (OLED) display unit, a speaker, or any combination thereof.

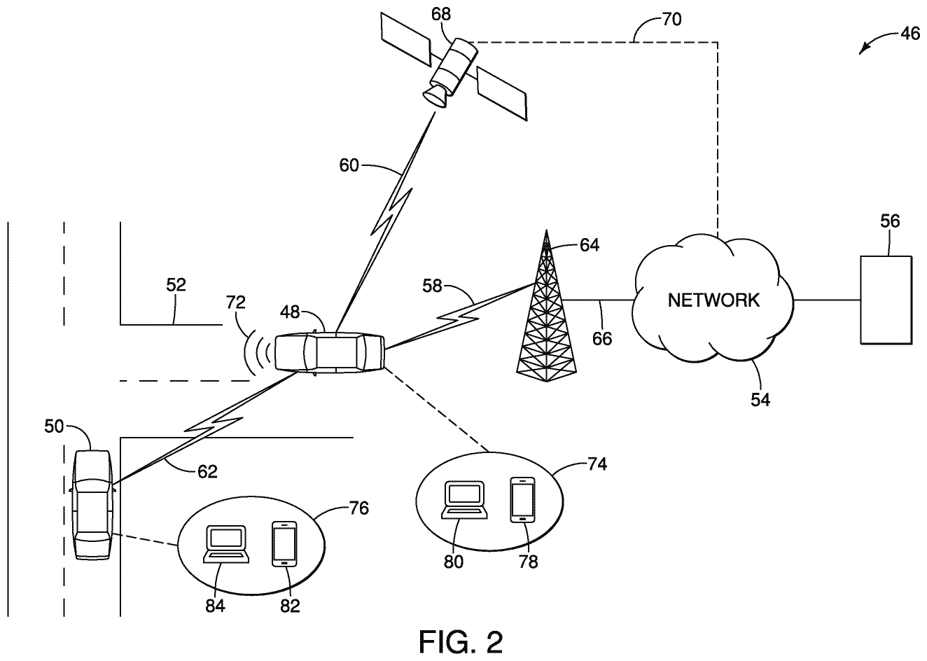

FIG. 2 is a diagram of an example of a portion of a vehicle transportation and communication system 46 in which the aspects, features, and elements disclosed herein may be implemented. The vehicle transportation and communication system 46 may include one or more vehicles 48 and 50, such as the vehicle 10 shown in FIG. 1, which may travel via one or more portions of one or more vehicle transportation networks 52, and may communicate via one or more electronic communication networks 54.

The electronic communication network 54 may be, for example, a multiple access system and may provide for communication, such as voice communication, data communication, video communication, messaging communication, or a combination thereof, between the vehicle 48/50 and one or more communication devices 56. For example, a vehicle 48/50 may receive information, such as information representing the vehicle transportation network 52, from a communication device 56 via the network 54.

In some embodiments, a vehicle 48/50 may communicate via a wired communication link (not shown), a wireless communication link 58/60/62, or a combination of any number of wired or wireless communication links. For example, as shown, a vehicle 48/50 may communicate via a terrestrial wireless communication link 58, via a non-terrestrial wireless communication link 60, or via a combination thereof. The terrestrial wireless communication link 58 may include an Ethernet link, a serial link, a Bluetooth link, an infrared (IR) link, an ultraviolet (UV) link, or any link capable of providing for electronic communication.

A vehicle 48/50 may communicate with another vehicle 48/50. For example, a host, or subject, vehicle (HV) 48 may receive one or more automated inter-vehicle messages, such as a basic safety message (BSM), from a remote, or target, vehicle (RV) 50, via a direct communication link 62, or via a network 54. For example, the remote vehicle 50 may broadcast the message to host vehicles within a defined broadcast range, such as 300 meters. In some embodiments, the host vehicle 48 may receive a message via a third party, such as a signal repeater (not shown) or another remote vehicle (not shown). A vehicle 48/50 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 48 may communicate with the communications network 54 via an access point 64. The access point 64, which may include a computing device, may be configured to communicate with a vehicle 48, with a communication network 54, with one or more communication devices 56, or with a combination thereof via wired or wireless communication links 58/66. For example, the access point 64 may be abase station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit in FIG. 2, an access point may include any number of interconnected elements.

The vehicle 48 may communicate with the communications network 54 via a satellite 68, or other non-terrestrial communication device. The satellite 68, which may include a computing device, may be configured to communicate with a vehicle 48, with a communication network 54, with one or more communication devices 56, or with a combination thereof via one or more communication links 60/70. Although shown as a single unit in FIG. 2, a satellite may include any number of interconnected elements.

An electronic communication network 54 may be any type of network configured to provide for voice, data, or any other type of electronic communication. For example, the electronic communication network 54 may include a local area network (LAN), a wide area network (WAN), a virtual private network (VPN), a mobile or cellular telephone network, the Internet, or any other electronic communication system. The electronic communication network 54 may use a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit in FIG. 2, an electronic communication network may include any number of interconnected elements.

The vehicle 48 may identify a portion or condition of the vehicle transportation network 52. For example, the vehicle 48 may include one or more on-vehicle sensors 72, such as sensor 38 shown in FIG. 1, which may include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 52. The sensor data may include lane line data, remote vehicle location data, or both.

The vehicle 48 may traverse a portion or portions of one or more vehicle transportation networks 52 using information communicated via the network 54, such as information representing the vehicle transportation network 52, information identified by one or more on-vehicle sensors 72, or a combination thereof.

Although, for simplicity, FIG. 2 shows two vehicles 48, 50, one vehicle transportation network 52, one electronic communication network 54, and one communication device 56, any number of vehicles, networks, or computing devices may be used. The vehicle transportation and communication system 46 may include devices, units, or elements not shown in FIG. 2. Although the vehicle 48 is shown as a single unit, a vehicle may include any number of interconnected elements.

Although the vehicle 48 is shown communicating with the communication device 56 via the network 54, the vehicle 48 may communicate with the communication device 56 via any number of direct or indirect communication links. For example, the vehicle 48 may communicate with the communication device 56 via a direct communication link, such as a Bluetooth communication link.

In some embodiments, a vehicle 48/50 may be associated with an entity 74/76, such as a driver, operator, or owner of the vehicle. In some embodiments, an entity 74/76 associated with a vehicle 48/50 may be associated with one or more personal electronic devices 78/80/82/84, such as a smartphone 78/82 or a computer 80/84. In some embodiments, a personal electronic device 78/80/82/84 may communicate with a corresponding vehicle 48/50 via a direct or indirect communication link. Although one entity 74/76 is shown as associated with one vehicle 48/50 in FIG. 2, any number of vehicles may be associated with an entity and any number of entities may be associated with a vehicle.

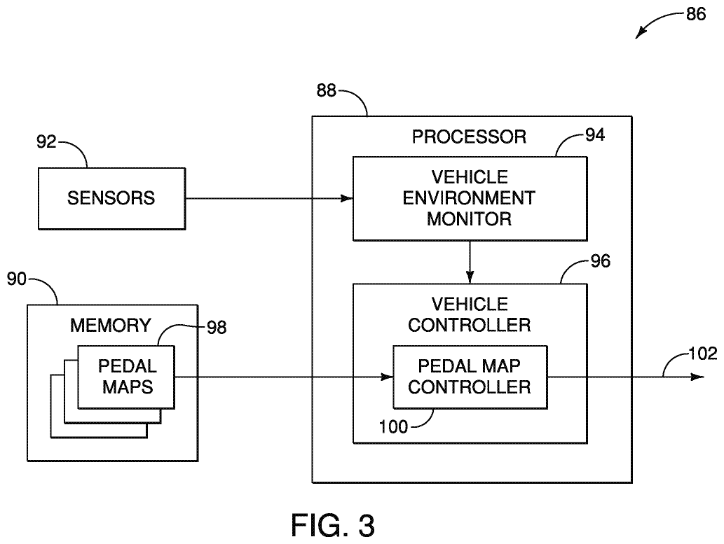

FIG. 3 is a diagram of an example of a one pedal, or e-pedal, control system 86 for use in a vehicle in accordance with this disclosure. The one pedal control system 86 includes a processor 88, such as processor 32 shown in FIG. 1, a memory 90, such as memory 34 shown in FIG. 1, and one or more sensors 92, such as sensor 38 shown in FIG. 1. The one-pedal control system 86 allows the electric vehicle 10 (FIG. 1) to be operated with one pedal that controls accelerating and braking.

The processor 88 includes a vehicle environment monitor 94 and a vehicle controller 96. The vehicle environment monitor 94 may correlate, associate, or otherwise process the operational environment data to determine a scene, or scene understanding. Determining a scene may include identifying, tracking, or predicting actions of one or more remote vehicles in the operational environment of the electric vehicle, such as information indicating a slow or stationary remote vehicle along the expected path of the electric vehicle, to identify one or more aspects of the operational environment of the electric vehicle, such as vehicle transportation network geometry in the operational environment of the electric vehicle, or a combination thereof geospatially corresponding to a lane-change operation. For example, the vehicle environment monitor 94 may receive information, such as sensor data, from the one or more sensors 92, which may correspond to one or more remote vehicles in the operational environment of the electric vehicle, one or more aspects of the operational environment of the electric vehicle in the operational environment of the electric vehicle or a combination thereof geospatially corresponding to a scene, such as, for example, associated with a lane-change operation. The vehicle environment monitor 94 may associate the sensor data with one or more identified remote vehicles in the operational environment of the electric vehicle, one or more aspects of the operational environment of the electric vehicle, or a combination thereof geospatially corresponding to a lane-change operation, which may include identifying a current or expected direction of travel, a path, such as an expected path, a current or expected velocity, a current or expected acceleration rate, or a combination thereof, for one or more of the respective identified remote vehicles. The vehicle environment monitor 94 may output the identified, associated, or generated scene information to, or for access by, the vehicle controller 96. The scene information may classify vehicles as in-lane, neighbor-lane, on-coming, or other classification. An in-lane vehicle may be classified as a lead vehicle that the host vehicle has identified to follow. A neighbor-lane vehicle may be classified as a neighbor vehicle that is in a neighbor lane. A neighbor vehicle may be re-classified as a lead vehicle after the host vehicle performs or is performing a lane change into the neighbor lane. An on-coming vehicle is a vehicle that is traversing in a direction towards the host vehicle, and may be in the same lane as the vehicle or a neighbor lane.

The memory 90 includes one or more pedal maps 98. The pedal maps 98 may be referred to as accelerator maps and may be associated with driving modes, such as a normal mode, a regenerative mode, or a comfort mode. For example, a regenerative mode may provide a heavy deceleration (i.e., active braking) when the accelerator pedal is released, and a comfort mode may provide a minimal deceleration so as to provide a gliding experience when the accelerator pedal is released. A normal mode may be a blend of the regenerative mode and comfort mode where a moderate deceleration is provided. Each pedal map may be a representation of a method to convert the driver's accelerator pedal output (APO) to a driver torque request. A pedal map may be expressed as curves of torque versus speed and APO, and may be used to estimate a driver torque or acceleration request based on the driving mode, vehicle speed, and APO.

The vehicle controller 96 includes a pedal map controller 100 and is configured to receive the scene information from the vehicle environment monitor 94. The pedal map controller 100 is configured to select the pedal map in accordance with a selection made by the driver from the memory 90. The pedal map controller 100 may output a pedal map change request 102 when the driver selects an automatic mode, as described below.

The vehicle 10 is equipped with an accelerator pedal that is operated by a driver to modulate vehicle speed. An accelerator pedal output (APO) is a number from 0-100%. The vehicle uses a lookup table (APT), which is one of the pedal maps 98 stored in the memory 90 (FIG. 3). Based on the APO and the vehicle speed, the APT outputs a torque request, or vehicle acceleration. For vehicles using one-pedal control, the APT is configured to request very high deceleration values when the APO is 0% to provide one-pedal driving.

Conventional electric vehicles include two settings to control behavior of the accelerator pedal. The driver can select between operating in a drive mode or an e-Pedal mode. The e-pedal mode allows the vehicle to be controlled with one pedal. The D-Mode is a driving mode that resembles driving a gas-powered vehicle. In other words, the vehicle is controlled using both the accelerator and brake pedals. The D-mode does not include regenerative braking. In other words, when the accelerator pedal is at 0% (i.e., not being pressed by the driver), regenerative braking does not occur to reduce the speed of the vehicle and generate power to be transmitted to a battery. Driving in the D-mode provides a light and fast accelerator pedal feeling, and provides little deceleration when the accelerator pedal is not operated. Driving in a conventional c-Pedal mode requires a substantial amount of accelerator pedal movement to control the vehicle such that the driver is substantially constantly adjusting the position of the accelerator pedal. In the conventional e-pedal mode, the vehicle may experience too much deceleration sometimes when no other road users are around), too little deceleration at other times.

In the pedal control system and method for an electric vehicle of the present disclosure, the driver selects between driving in a first mode and a second mode. The selected mode controls operation of the accelerator pedal. In the electric vehicle, the driver manipulates the accelerator pedal position (APP), or APO, to convey a torque request to the vehicle. The APO is converted to a torque request through a lookup-table, such as a pedal map 98 (FIG. 3).

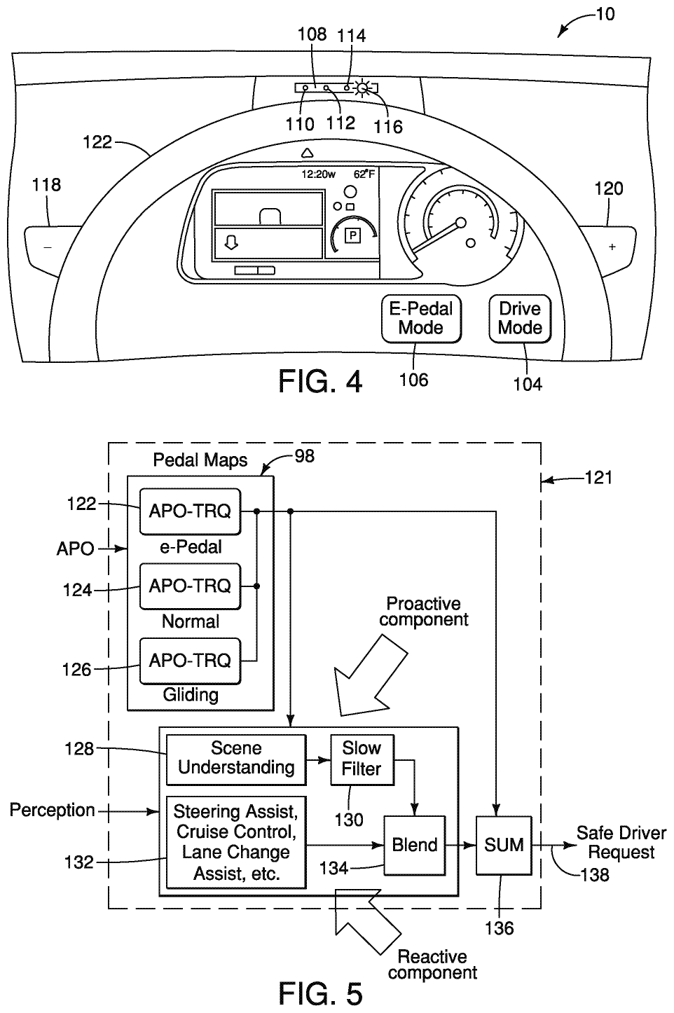

The electric vehicle 10 includes two settings to control behavior of the accelerator pedal, as shown in FIG. 4. A first button, or switch, 104 activates the drive mode, or D-mode. A second button, or switch, 106 activates an e-Pedal mode, which allows the vehicle to be controlled with one pedal. Although shown as two buttons 104 and 106, the D-mode and the c-pedal mode can be manually selected in any suitable manner.

Selecting the first button 104 activates the D-mode, or first mode, which resembles operating a gas-powered vehicle. In other words, the driver controls the vehicle with both the accelerator and brake pedals. The D-mode does not include regenerative braking.

Selecting the second button 106 activates the e-pedal mode, or second mode, which allows operation of the electric vehicle 10 with one pedal, i.e., the accelerator pedal. The c-pedal mode includes regenerative braking. The c-pedal mode includes a plurality of sub-modes. The plurality of sub-modes includes a first sub-mode, a second sub-mode, a third sub-mode, and an automatic sub-mode. Although described with four sub-modes, the c-pedal mode can include any suitable number of sub-modes.

A sub-mode display 108 on the instrument panel indicates the sub-mode of the e-pedal mode in accordance with which the accelerator pedal is operated. The sub-mode display 108 includes a first sub-mode indicator 110, a second sub-mode indicator 112, a third sub-mode indicator 114, and an automatic sub-mode indicator 116.

Toggle switches 118 and 120 toggle through the plurality of sub-modes when the e-pedal mode, or second mode, is selected, as shown in FIG. 4. The driver can select to control the accelerator pedal in accordance with one of the plurality of sub-modes, such as the first sub-mode, the second sub-mode, the third sub-mode, or the automatic sub-mode. Each of the first, second and third sub-modes is a predefined sub-mode corresponding to a pedal map stored in the memory 90. Each of the predefined sub-modes has a different rate of deceleration and regeneration. In the automatic sub-mode, the pedal map controller 100 determines one of the predefined sub-modes in accordance with which the accelerator pedal is controlled. In other words, when the automatic sub-mode is selected, the controller 100 determines whether the accelerator pedal is operated in accordance with the first, second or third sub-mode. The controller 100 controls the operating mode of the accelerator pedal when the e-pedal mode is selected.

The driver manipulates the accelerator pedal position (APP), or APO, to convey a torque request to the vehicle. The APO is converted to a torque request through a lookup-table, such as the pedal map 98 stored in the memory 90 (FIG. 3). When the driver selects the e-pedal mode with the e-pedal mode button 106, the driver can then manually select one of the four predefined sub-modes in real-time according to their preferences using paddle shifters 118 and 120 or a dedicated button on or in the vicinity of the steering wheel 122.

In the predefined sub-modes (i.e., the first, second and third sub-modes), the driver experiences a substantially constant APO-to-torque conversion based on the pedal map that is independent of the scene sensed by the sensors 92 (FIG. 3). In the first sub-mode, indicated by the first sub-mode indicator 110 being illuminated, maximum deceleration and regeneration occur. In the second sub-mode, indicated by the second sub-mode indicator 112 being illuminated, moderate deceleration and regeneration occur. The second sub-mode is a setting between the first sub-mode and the D-mode. The third sub-mode, indicated by the third sub-mode indicator 114 being illuminated, has the least deceleration and regeneration, and is similar to the D-mode.

In the automatic sub-mode, indicated by the automatic sub-mode indicator 116 of the sub-mode display 108, the pedal map 98 associated with the predefined pedal map is modified with proactive and reactive adjustments, as shown in FIG. 5.

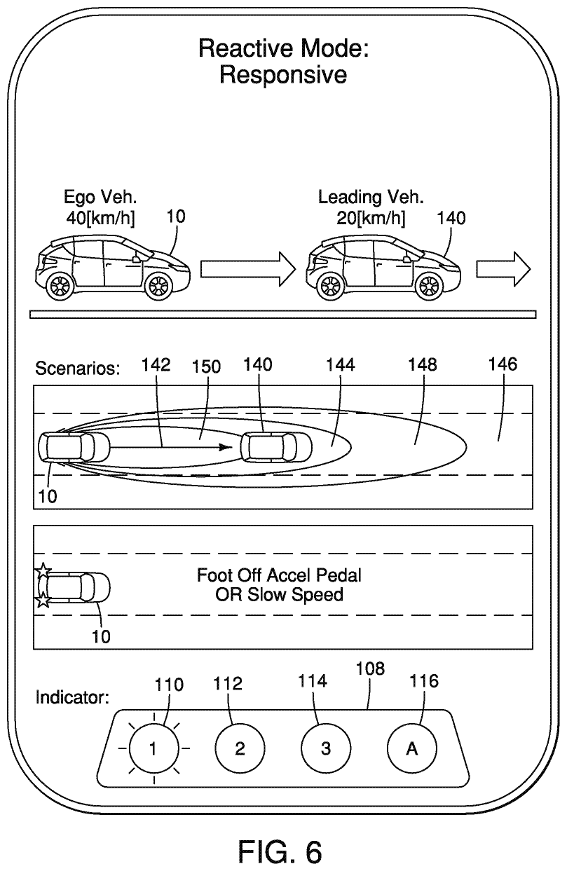

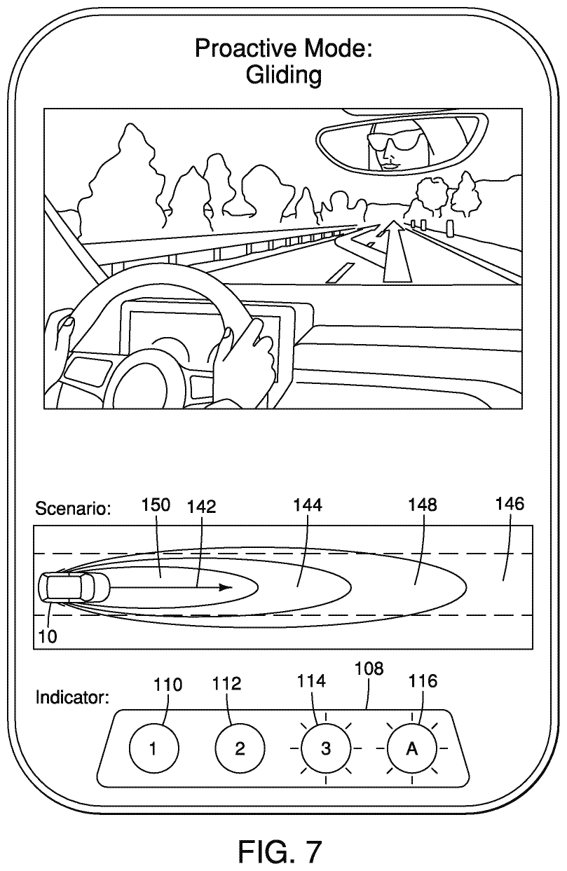

As shown in FIG. 5, the automatic sub-mode pedal control system 121 modifies the pedal map based on a proactive component and a reactive component. The pedal maps 98 include, but are not limited to, an e-pedal or predefined sub-mode 1 122, a normal, or predefined sub-mode 2 124, and a gliding, or predefined sub-mode 3 126. The proactive component, which in the absence of other road users as shown in FIG. 7, makes the accelerator pedal feel more like the D-Mode for easy coasting. The reactive component, which in the presence of a lead vehicle as shown in FIG. 6, makes the vehicle decelerate more than the baseline e-Pedal.

When the automatic sub-mode 116 is selected, as shown in FIG. 5, the automatic sub-mode pedal control system 121 determines whether to change the current pedal map based on the proactive component and the reactive component. The proactive component of the automatic sub-mode pedal control system 121 includes determining the scene, or surroundings, 128 of the host vehicle 10, as shown in FIG. 5, with the sensor 92. The sensor 92 is configured to obtain sensor data to determine the scene associated with the operational environment of the vehicle 10. The sensor data includes, but is not limited to, detection of a lead vehicle ahead of the host vehicle and an amount of time that the lead vehicle is ahead of the host vehicle. The determined scene 128 is output to a slow filter 130. The reactive component of the automatic sub-mode pedal control system 121 includes determining whether a reactive system 132 of the vehicle is active. The reactive system 132 includes, but is not limited to, steering assist system, a cruise control system, and a lane change assist system. The reactive system 132 is a system of the host vehicle 10 that controls operation of the host vehicle 10 based on other vehicles in the vicinity of the host vehicle 10. The reactive component provides a safer drive when following a lead vehicle. The output from the reactive system 132 is combined with the output from the slow filter 130 at an adder 134. The output from the adder 134 is combined with the current pedal map 98 to determine whether to transmit a command 138 to change the current pedal map 98 when the automatic sub-mode 116 is selected. The command 138 changes the current pedal map to a more suitable pedal map for the current environment surrounding the host vehicle 10, thereby providing a safer driving environment.

For example, when the host vehicle is taking an exit from a highway to an exit ramp when the automatic sub-mode is selected, the automatic sub-mode pedal control system 121 may determine to switch the predefined mode from the third predefined sub-mode to the first predefined sub-mode to increase the rate of deceleration. When the host vehicle is entering a highway from an exit ramp when the automatic sub-mode is selected, the automatic sub-mode pedal control system 121 may determine to switch the predefined mode from the third predefined sub-mode to the second predefined sub-mode to slightly decrease the rate of deceleration when a lead vehicle is determined to be within an approximately two to five second time headway (THW) 142 (FIGS. 6 and 7). When the host vehicle is driving on the highway when the automatic sub-mode is selected, the automatic sub-mode pedal control system 121 may determine to switch the predefined mode from the second predefined sub-mode to the third predefined sub-mode to decrease the rate of deceleration when a lead vehicle is not determined to be within an approximately nine second THW of the host vehicle 10. The THW 142 can be determined by the sensor 92.

As shown in FIG. 6, when a lead vehicle 140 is between approximately two to five seconds of time headway (THW) 142 ahead of the host vehicle 10, the reactive component makes the APP-to-torque feel like a baseline e-Pedal, such as the predefined sub-mode 1. Area 144 in FIG. 6 illustrates the THW 142 being approximately two to five seconds between the host vehicle 10 and the lead vehicle 140.

For situations when the lead vehicle 140 is beyond approximately nine seconds of time headway (THW) 142 ahead of the host vehicle 10, the reactive component makes the APP-to-torque to feel like the D-Mode, such as the predefined sub-mode 3. Area 146 in FIG. 6 illustrates the THW 142 being larger than approximately nine seconds between the host vehicle 10 and the lead vehicle 140.

When the THW 142 is between approximately five to nine seconds, the reactive component makes the APP-to-torque feel somewhere between, such as the predefined sub-mode 2. Area 148 in FIG. 6 illustrates a THW 142 of approximately five to nine seconds between the host vehicle 10 and the lead vehicle 140.

When the lead vehicle 140 is less than approximately two seconds THW ahead of the host vehicle 10, the reactive component adds additional deceleration. Area 150 in FIG. 6 illustrates a THW of less than approximately two seconds between the host vehicle 10 and the lead vehicle 140.

As shown in FIG. 6, the THW 142 between the host vehicle 10 and the lead vehicle 140 is in the area 144 indicating approximately two to five seconds. As indicated in the sub-mode display 108, the automatic sub-mode is selected. Based on the THW 142 being in the area 144 indicating approximately two to five seconds, the predefined sub-mode 1 is automatically selected by the controller 100.

As shown in FIG. 6, when a lead vehicle is not present in the environment of the host vehicle 10 and the driver is not pressing the accelerator pedal or is driving at a slow speed (e.g., less than fifteen miles per hour), the predefined sub-mode 1 is automatically selected by the controller 100 when the automatic sub-mode is manually selected. The predefined sub-mode 1 provides a maximum rate of deceleration and regeneration in view of the slow driving speed and/or the accelerator pedal not being pressed.

As shown in FIG. 7, when a lead vehicle 140 is greater than approximately nine seconds THW ahead of the host vehicle 10, the proactive component of the automatic sub-mode pedal control system 121 results in the third predefined sub-mode 114 being automatically selected when the automatic sub-mode 116 is manually selected. A lead vehicle is not present in any of the THW areas 150, 144 and 148, as shown in FIG. 7. In the absence of a lead vehicle within approximately nine seconds THW of the host vehicle 10, the third predefined sub-mode is selected, which provides the lowest rate of deceleration and regeneration.

The controller 100 is configured to select one of the plurality of predefined sub-modes based on whether the lead vehicle 140 is detected ahead of the host vehicle 10, as shown in FIGS. 6 and 7. Upon determining the lead vehicle 140 ahead of the host vehicle 10, as shown in FIG. 6, the controller 100 is configured to select one of the plurality of predefined sub-modes based on an amount of time, or TRW 142, that the lead vehicle 140 is ahead of the host vehicle 10. As shown in FIG. 6, a THW between approximately five to nine seconds indicates the lead vehicle 140 in area 144, such that the predefined sub-mode 2 is automatically selected. Additional deceleration is added to the selected predefined sub-mode when the amount of time, or THW, is less than a predetermined amount of time, such as less than two seconds. The lower the amount of time, or THW, the larger the rate of deceleration and regeneration associated with the corresponding predefined sub-mode. The first predefined sub-mode corresponding to a THW of approximately two to five seconds (e.g., area 144) has a larger rate of deceleration and regeneration than the THW of approximately five to nine seconds (e.g., area 148). The controller 100 is configured to automatically switch between the predefined sub-modes when the amount of time, or THW, changes. When the lead vehicle 140 changes from THW area 144 to THW area 148 when the automatic sub-mode is manually selected, the predefined sub-mode automatically changes from predefined sub-mode 2 to predefined sub-mode 3 to adjust to the change in THW between the host vehicle 10 and the lead vehicle 140.

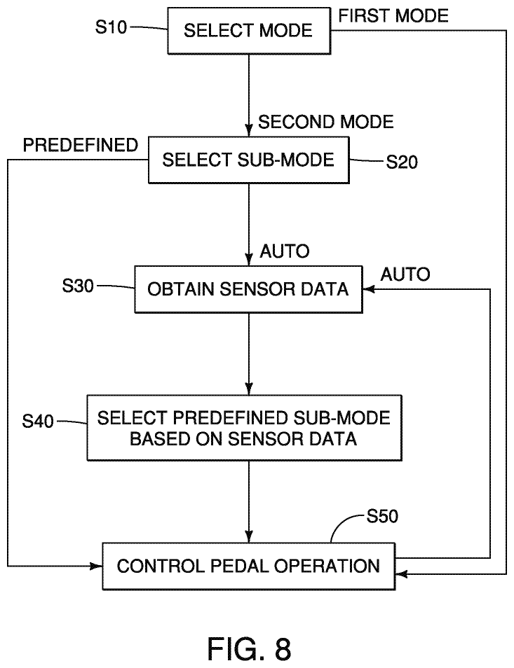

A flowchart illustrating operation of the automatic sub-mode pedal control system 121 (FIG. 5) is shown in FIG. 8. In step S10, whether to operate the accelerator pedal in accordance with a first mode or a second mode is selected. The first mode, such as a D-mode, is selected by pressing button 104 (FIG. 4) and does not include regenerative braking. The second mode, such as the e-pedal mode, is selected by pressing button 106 (FIG. 4), and includes regenerative braking. When the first mode is selected in step S10, the process moves to step S50, and the accelerator pedal is controlled accordingly.

When the second mode is selected in step S10, the process moves to step S20. The second mode includes a plurality of sub-modes. The plurality of sub-modes includes a plurality of predefined sub-modes and an automatic sub-mode. In step S20, one of the plurality of sub-modes is manually selected.

When one of the plurality of predefined sub-modes is manually selected in step S20, such as the first, second, or third predefined sub-modes, the process moves to step S50 and the accelerator pedal is controlled accordingly. As shown in FIG. 4, the toggle switches 118 and 120 can be used to manually select one of the plurality of predefined sub-modes. Each of the plurality of predefined sub-modes has a different rate of deceleration and regeneration.

When the automatic sub-mode is selected in step S20, the process moves to step S30. In the automatic sub-mode, one of the plurality of predefined sub-modes is automatically selected. The sensor 92 (FIG. 4) obtains sensor data to determine the scene associated with the operational environment of the host vehicle 10. The sensor data includes, but is not limited to, detection of a lead vehicle 140 (FIGS. 6 and 7) ahead of the host vehicle 10, and an amount of time that the lead vehicle 140 is ahead of the host vehicle 10. The determination of which other vehicles to account for in the scene is based on a predetermined region-of-interest ahead of the host vehicle 10, such as shown in FIGS. 6 and 7. When the driver turns a turn signal on, the region-of-interest is increased in that direction.

The process moves to step S40 in which one of the predefined sub-modes is selected based on the obtained sensor data in step S30. The predefined sub-mode is selected based on whether the lead vehicle 140 is detected ahead of the host vehicle 10, as shown in FIGS. 6 and 7. Upon determining the lead vehicle 140 is ahead of the host vehicle 10, as shown in FIG. 6, the predefined sub-mode is selected based on the amount of time that the lead vehicle 140 is ahead of the host vehicle 10. The process moves to step S50 and the accelerator pedal is controlled accordingly.

Additional deceleration is added to the selected predefined sub-mode when the amount of time is determined to be less than a predetermined amount of time, such as less than approximately two seconds. Additional deceleration can be added by increasing the deceleration rate by a predetermined amount. As shown in FIG. 6, the predefined sub-mode is changed when the amount of time between the host vehicle 10 and the lead vehicle 140 changes. The automatic sub-mode pedal control system reduces accelerator pedal variance. As shown in FIG. 8, the process moves from step S50 to step S30 such that the sensor 92 (FIG. 4) can continue to obtain sensor data, and the predefined sub-mode can be changed as appropriate in step S40 and the accelerator pedal controlled accordingly in step S50.

User preferences can be learned by collecting data regarding how the plurality of sub-modes are changed. The data collected by the host vehicle 10 can be transmitted via the network 54 for analysis. Based on the analyzed data, the operation of the automatic sub-mode can be tuned to the preferences of the driver of the host vehicle 10. Collected data can be shared between vehicles, such as vehicles 48 and 50 (FIG. 2), to provide a versatile and customizable pedal control system.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section.” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of an electric vehicle equipped with the pedal control system and method. Accordingly, these terms, as utilized to describe the present invention should be interpreted relative to an electric vehicle equipped with the pedal control system and method.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pedal control system for an electric vehicle comprising:
a pedal configured to be operated in a first mode or a second mode, the first mode not including regenerative braking and the second mode including regenerative braking, the second mode including a plurality of sub-modes;
a first switch configured to switch between the first mode and the second mode;
a second switch configured to select one of the plurality of sub-modes when the second mode is selected; and
an electronic controller configured to control an operating mode of the pedal when the second mode is selected,
each of the plurality of sub-modes having a different rate of deceleration and regeneration.

2. The pedal control system according to claim 1, wherein
the plurality of sub-modes includes an automatic mode and a plurality of predefined sub-modes.

3. The pedal control system according to claim 2, wherein
the automatic mode selects one of the plurality of predefined sub-modes in which the pedal is operated.

4. The pedal control system according to claim 3, wherein
a sensor is configured to obtain sensor data to determine a scene associated with an operational environment of the vehicle.

5. The pedal control system according to claim 4, wherein
the sensor data obtained by the sensor includes detection of a lead vehicle ahead of the vehicle, and an amount of time that the lead vehicle is ahead of the vehicle.

6. The pedal control system according to claim 5, wherein
the electronic controller is configured to select one of the plurality of predefined sub-modes based on whether a lead vehicle is detected ahead of the vehicle.

7. The pedal control system according to claim 6, wherein
upon determining a lead vehicle ahead of the vehicle, the electronic controller is further configured to select one of the plurality of predefined sub-modes based on the amount of time that the lead vehicle is ahead of the vehicle.

8. The pedal control system according to claim 7, wherein
additional deceleration is added to the selected predefined sub-mode when the amount of time is less than a predetermined amount.

9. The pedal control system according to claim 7, wherein
the one of the predefined sub-modes associated with a smaller amount of time includes a larger rate of deceleration than another of the predefined sub-modes associated with a larger amount of time.

10. The pedal control system according to claim 7, wherein
the electronic controller is configured to switch between the plurality of predefined sub-modes when the amount of time changes.

11. The pedal control system according to claim 2, wherein
a sensor detects whether a lead vehicle is present and an amount of time between the lead vehicle and the vehicle,
an additional deceleration being added to the selected predefined sub-mode when the detected amount of time is less than a predetermined amount of time.

12. A method of controlling an electric vehicle comprising:
selecting to operate a pedal in accordance with a first mode or a second mode, the first mode not including regenerative braking and the second mode including regenerative braking, the second mode including a plurality of sub-modes;
selecting one of the plurality of sub-modes when the second mode is selected; and
controlling an operating mode of the pedal when the second mode is selected,
each of the plurality of sub-modes having a different rate of deceleration and regeneration.

13. The method according to claim 12, wherein
the plurality of sub-modes includes an automatic sub-mode and a plurality of predefined sub-modes.

14. The method according to claim 13, wherein
automatically selecting one of the plurality of predefined sub-modes in which the pedal is operated when the automatic sub-mode is selected.

15. The method according to claim 14, wherein
obtaining sensor data to determine a scene associated with an operational environment of the vehicle.

16. The method according to claim 15, wherein
the sensor data obtained by the sensor includes detection of a lead vehicle ahead of the vehicle, and an amount of time that the lead vehicle is ahead of the vehicle.

17. The method according to claim 16, wherein
the one of the plurality of predefined sub-modes is selected based on whether a lead vehicle is detected ahead of the vehicle.

18. The method according to claim 17, wherein
upon determining a lead vehicle ahead of the vehicle, the one of the plurality of predefined sub-modes is selected based on the amount of time that the lead vehicle is ahead of the vehicle.

19. The method according to claim 18, wherein
adding additional deceleration to the selected predefined sub-mode when the amount of time is less than a predetermined amount.

20. The method according to claim 18, further comprising
switching between the plurality of predefined sub-modes when the amount of time changes.
